(19) United States
(12) Patent Application Publication
(10) Pub. No.: US 2002/0073607 A1
(43) Pub. Date: Jun. 20, 2002

(54) Fishing lure

(76) Inventors: Teresa Hickok, Bonita, CA (US); King Tom, San Diego, CA (US)

Correspondence Address: FRELING E. BAKER, 12625 HIGH BLUFF DRIVE, SUITE 203, SAN DIEGO, CA, 92130, US

(21) Appl. No.: 09/741,685

(22) Filed: Dec. 18, 2000

(51) Int. Cl. A01K 85/16

(52) U.S. Cl. 43/42.25; 43/42.28

(57) ABSTRACT

A fishing lure includes an elongate stepped generally cylindrical body having a front end and a rear end, a front generally cylindrical portion having a first diameter, an intermediate generally cylindrical portion having a second diameter greater than said first diameter, a rear generally cylindrical portion having a third diameter, and a generally radially extending shoulder between said front portion and said intermediate portion. A skirt is detachably mounted on the rear cylindrical portion of the body to enhance the appearance of the lure to a fish.

### BACKGROUND OF THE INVENTION

The present invention relates to fishing lures and pertains more particularly to artificial lures designed for trolling for salt water fish.

Fishing lures are designed to attract fish by mimicking the motions and sounds of the creatures of nature, such as smaller fish, which the particular fish normally eat. Thus, different fish may require different type lures that have different sound, appearances and motion. Certain salt water or ocean dwelling fish, for example, feed on small fish and the like near the surface of the water. Lures for these fish are typically towed on lines behind a moving boat (trolling) and preferably have a motion moving side to side with frequent jumping from the water like a fish swimming.

The most desirable characteristics of a lure is that it attract the attention of the fish they are designed to catch. The lure must be designed do this primarily by appearance, motion and sound. One of the desirable characteristics of a lure is that it act in motion like a target of the fish being lured. One favorable characteristic is that it create a long trailing bubble stream behind it. Another desirable characteristic is that it wiggle side to side like a small fish swimming. A further characteristic is that it frequently leap or jump from the water. Still another desirable characteristic for economy and utility is that it is tough and durable with a reasonable useful life.

While many of the prior art lures have some of these desirable features they are not entirely satisfactory. They are typically constructed to have an appearance and motion similar to a swimming fish when in motion. One major drawback to these prior art lures is that they are made of either wood or plastic and typically have a skirt that is permanently attached. The result is that these prior art lures are fragile and have a short life. They are often broken or damaged on the first strike. The skirt is permanently affixed and cannot be replaced if damaged.

Accordingly, here is a need for fishing lures that have the desirable sound, appearance and motion characteristics and a long life.

### SUMMARY AND OBJECT OF THE INVENTION

It is the primary object of the present invention to provide an improved fishing lure having improved sound, appearance and motion and a long life.

In accordance with a primary aspect of the present invention a fishing lure comprises an elongate stepped generally cylindrical body having a front end and a rear end, a front generally cylindrical portion having a first diameter, an intermediate generally cylindrical portion having a second diameter greater than said first diameter, a rear generally cylindrical portion having a third diameter less than said intermediate portion, and a generally radially extending shoulder between said front portion and said intermediate portion.

### BRIEF DESCRIPTION OF DRAWINGS

The objects, advantages and features of this invention will be more readily appreciated from the following detailed description, when read in conjunction with the accompanying drawing, in which:

FIG. 1 is a perspective view of a body of a lure in accordance with a preferred embodiment of the invention;

FIG. 2 is a side elevation view of the assembled lure of FIG. 1;

FIG. 3 is a perspective view of a body of a lure in accordance with an alternate embodiment of the invention;

FIG. 4 is a side elevation view of the assembled lure of FIG. 1; and

FIG. 5 is a side elevation view of a lure plug with a further modification.

### DETAILED DESCRIPTION OF THE INVENTION

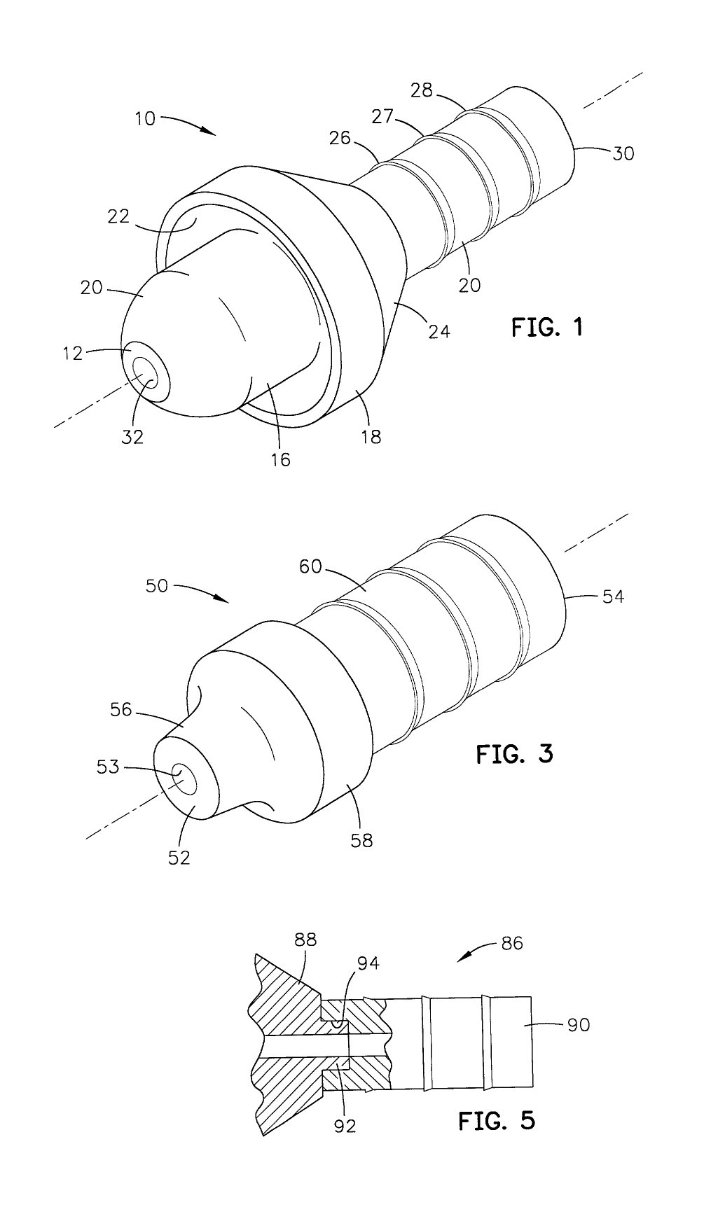

Referring to FIG. 1 of the drawing, a main body of a lure in accordance with the invention is illustrated in perspective view and designated generally by the numeral 10. The illustrated embodiment comprises an elongated stepped generally cylindrical body having a front end 12, a rear end 14. The body is formed with a front generally cylindrical portion 16 having a first diameter, a larger diameter intermediate generally cylindrical portion 18 having a second diameter, and a rear generally cylindrical portion 20 having a third diameter less than either the first front portion diameter or the intermediate diameter. The very front or nose of the body has a generally semi-spherical configuration or portion 22 curving from the very front 12 up to the first diameter portion 16.

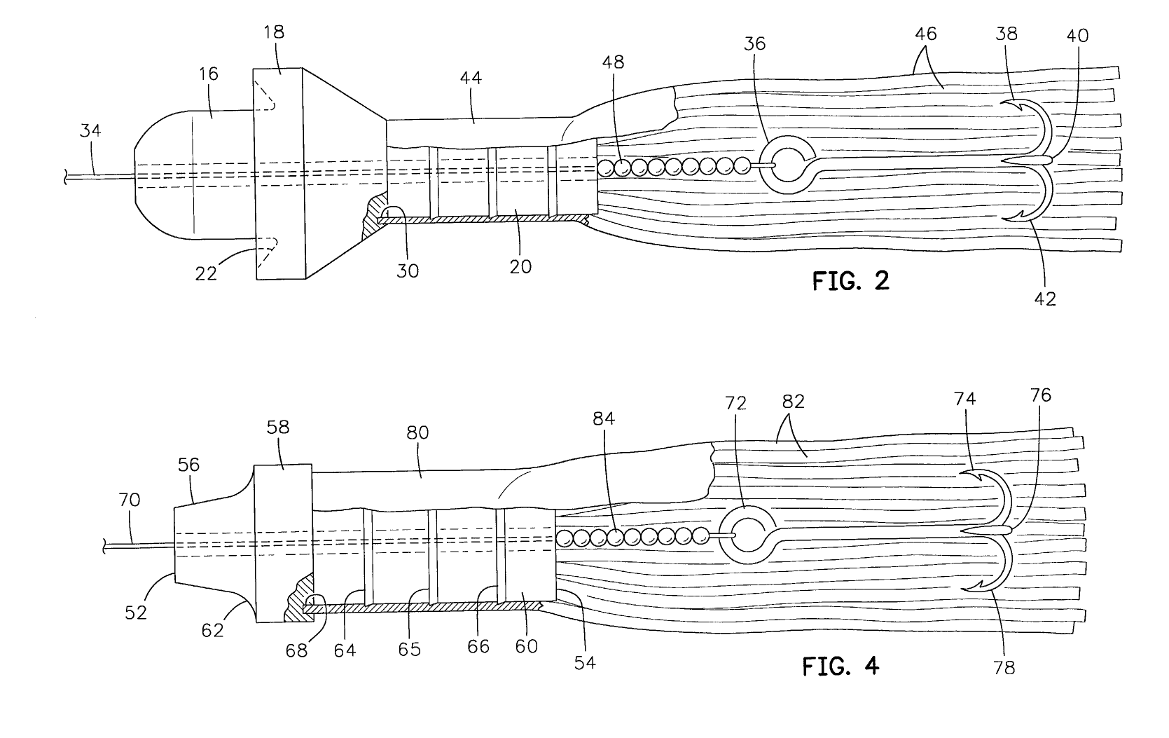

The intermediate diameter portion 18 having a greater diameter than the front portion forms a forwardly directed shoulder 22 which in the illustrated embodiment is preferably cupped at the front or forward surface. This cup portion preferably has a forwardly directed generally frusto-conical configuration. This shoulder provides resistance in moving through the water that causes the lure to wiggle from side to side mimicking the swimming motion of a fish. The trailing end of this intermediate portion 18 also has a generally frusto-conical configuration tapering down at 24 from the intermediate diameter 18 to the rear diameter portion 20. The rear generally cylindrical portion 20 is formed with one or more barbs 26, 27 and 28 which function to releasably retain a skirt, to be described, in place on the rear generally cylindrical portion of the body. This construction enables skirts to be removed and replaced when damaged or when different color or design skirt is desired on the lure. An annular groove 30 is formed in a rear portion of the center or intermediate portion 18 of the body to receive the forward end of a skirt as shown in FIG. 2.

The body for most applications is preferably formed of a metal such as an aluminum or an alloy thereof, or titanium or an alloy thereof. Such materials are light in weight, hard and durable and will give the lure a long, useful life. They are also sufficiently light in weight that they can be easily controlled near the surface of the water. In addition, aluminum and titanium can be treated by anodizing to give the body a bright colorful attractive appearance that enhances the visibility of the lure to saltwater fish. Anodizing, generally, is a well known treatment and will not be discussed in detail. However, applicant has available a process to create graphics, shading and various color schemes that make the lure more visible and attractive. The process is available to applicant under the trademarks ETERNAL GRAPHICS and ETERNAL LOOM from George Industries, Los Angeles, Calif. The process can create various shading and coloring to give the lure the coloring and shading of a fish with a darker top changing to a silver on its bottom.

The body is also formed with a coaxial bore 32, extending the full length thereof for receiving and mounting a line and hook. The hook as shown in FIG. 2, includes an elongate shaft 34 with a loop 36 at the forward end in which a fishing line is attached that extends through the bore 32 to the forward end of the body. A plurality of beads 48 or any other suitable means may be used to space the forward end of the hook from the rear end of the body and position the hook. The shaft of the hook as illustrated is formed with a hook assembly that may have a single hook or three barbed hooks 38, 40 and 42 as illustrated. The lure may also have other arrangements of one or more hooks as desired. The plurality of beads 48 enable the hook to be selectively positioned behind the body any suitable distance as desired. Other means such as a knot in the line (not shown) may also be used.

A skirt comprising a front tubular portion 44 with a plurality of elongated stringers 46 is mounted on the rear cylindrical portion 20 of the body and the stringers trail behind the body and extends over the hook. The skirt may be formed such as from a tubular elastomeric member or elastomeric tube slit along the major length thereof forming a plurality of stringers 46. The skirt forms an extension of the body portion with a flexible moveable portion that when in water mimics the action of a small fish. The tubular portion of the skirt is mounted on the aft or rear cylindrical portion of the body and held in place by a plurality of small annular barbs as above described. The forward end of skirt portion 44 extends into annular slot 30 in the body and creates a smooth transition between body and skirt. This construction enables the removal of a skirt by dipping it in warm water and slipping it off the rear portion of the body. Thus, skirts can be replaced to change the appearance of the lure. Also, damaged skirts can be replaced giving the lure a longer life.

The stepped diameter construction with a radial shoulder intermediate the ends of the body has been found to provide a desirable movement and action of the lure as it moves through the water behind a boat. The lures are typically trolled at a speed of about seven knots and in tests of the present lure it has been found to provide the desirable movement characteristics. The lure moves from side to side mimicking the swimming action of a fish and periodically leaps or jumps from the water surface and splashes the water when it reenters. The lure also leaves a long bubble trail behind it. This action attracts the attention of fish. The present lure has been found to be particularly attractive for larger fish such as marlin and tuna.

A typical dimension for a lure in accordance with this invention for a marlin would have a body with a length of about 1½ to 2 inches with a forward portion diameter of about ½ to ¾ of an inch in diameter and an intermediate diameter of about 1 inch with a rear portion diameter of approximately ½ inch. This body with the skirt and stringers provides a lure of about the right size for a marlin or the like. A lure for tuna is preferably slightly smaller such about 1 to 1½ inches in length with proportionate diameters.

Referring to FIGS. 3 and 4 of the drawings, an alternate embodiment of the invention is illustrated and designated generally by the numeral 50. The lure body 50 of the alternate embodiment has the same general configuration of that of the prior embodiment with a front end 52, a rear end 54. The body is constructed with a stepped diameter having a front portion having a somewhat cylindrical diameter 56 with an intermediate diameter cylindrical portion 58 and rear generally cylindrical portion 60. The front generally cylindrical portion 56 in a preferred embodiment tapers slightly from the forward most end toward the rear and forms into a shoulder 62 that curves up in a convex configuration to the intermediate diameter 58. In this embodiment, the nose or front end portion 52 is illustrated as blunt on the end with the forward diameter portion 56 slightly less in diameter than the rear diameter portion 58. A plurality of annular barbs 64, 65 and 66 encircle the rear cylindrical portion 60 to retain a skirt in place as in the previous embodiment. An annular groove 68 is formed in a rear portion of the center or intermediate portion 58 of the body to receive the forward end of a skirt as shown in FIG. 4.

A skirt comprising a front tubular portion 80 with a plurality of elongated stringers 82 as in the prior embodiment is mounted on the rear cylindrical portion 20 of the body. The stringers trail behind the body and extends over and covers the hook. The skirt may be formed such as from a tubular elastomeric member or elastomeric tube slit along the major length thereof forming a plurality of stringers 82. The skirt forms an extension of the body portion with a flexible moveable portion that when in water mimics the action of a small fish swimming.

A prototype of this embodiment has been constructed and tested and found to be satisfactory in that it also produces a motion that satisfactorily mimics the movement a small fish. A test sample of this embodiment had a body with dimensions on the order of about 1.25 inches in length with a diameter at the forward cylindrical portion of between 0.24 and 0.30 inches. The intermediate cylindrical diameter portion had a diameter of about 0.50 inches with the rear portion having a diameter of about 0.40 inches. The embodiment was equipped with a skirt substantially as in the previous embodiment. All embodiments of these lures may be made in many different sizes.

Referring to FIG. 5 and additional feature that may be embodied into either embodiment is illustrated. As shown, a body designated generally by the numeral 86, has a front portion 88 and a rear portion 90 joined a joint comprising a cylindrical plug 92 and a cylindrical bore or socket 94. The plug is preferably press fitted into the socket, but may be connected by threads or other means. With this construction, the front body portion may be formed of aluminum or titanium and the rear portion formed of a heavier metal such as stainless steel, brass or other metal in order to adjust the weight, balance and buoyancy of the body. The depth of trolling of the lure can thus be adjusted or selected by selecting the materials from which the body is constructed.

We claim:

1. A fishing lure comprising:
an elongate stepped generally cylindrical body having a front end and a rear end, a front generally cylindrical portion having a first diameter, an intermediate generally cylindrical portion having a second diameter greater than said first diameter, a rear generally cylindrical portion having a third diameter less than said intermediate portion, and a generally radially extending shoulder between said front portion and said intermediate portion.

2. A lure according to claim 1, wherein said shoulder is cupped.

3. A lure according to claim 2, wherein said front end is semi-spherical.

4. A lure according to claim 1, wherein said front end is semi-spherical.

5. A lure according to claim 1, wherein said front portion first diameter is greater than said third diameter.

6. A lure according to claim 5, wherein said shoulder is cupped.

7. A lure according to claim 6, wherein said shoulder is a frustrum of a cone.

8. A lure according to claim 1, wherein said shoulder is a frustrum of a cone.

9. A lure according to claim 8, wherein said front end portion first diameter is greater than said third diameter.

10. A lure according to claim 9, wherein said front end is semi-spherical.

11. A lure according to claim 1, further comprising annular barb means on said rear cylindrical portion and a skirt detachably mounted on said rear cylindrical portion.

12. A lure according to claim 1, end wherein said front portion first diameter is less than said third diameter.

13. A lure according to claim 12, wherein said front portion tapers from said front end to said shoulder.

14. A lure according to claim 13, wherein said shoulder is concave.

15. A lure according to claim 13, further comprising annular barb means on said rear cylindrical portion and a skirt detachably mounted on said rear cylindrical portion.

16. A lure according to claim 1, wherein:
a first portion of said body is made of an alloy taken from the group consisting of aluminum and titanium; and
a second portion of said body is made of a material taken from the group consisting of stainless steel and brass.

17. A fishing lure comprising:
an elongate stepped generally cylindrical body made of an alloy taken from the group consisting of aluminum and titanium, the body having a front end and a rear end, a front generally cylindrical portion having a first diameter, an intermediate generally cylindrical portion having a second diameter greater than said first diameter, a rear generally cylindrical portion having a third diameter less than said intermediate portion, a generally radially extending shoulder between said front portion and said intermediate portion, a bore extending co-axially of said body from said front end to said back end;
a fish hood mounted in said bore and having a loop at said front end and a hook at said rear end; and
a skirt mounted on said rear generally cylindrical portion and extending at least partially over said hook.

18. A lure according to claim 17, wherein said shoulder is cupped.

19. A lure according to claim 18, wherein said front end is semi-spherical.

20. A lure according to claim 17, wherein said shoulder is concave.

21. A lure according to claim 17, further comprising annular barb means on said rear cylindrical portion and a skirt detachably mounted on said rear cylindrical portion.

22. A lure according to claim 17, wherein:
a first portion of said body is made of an alloy taken from the group consisting of aluminum and titanium; and
a second portion of said body is made of a material taken from the group consisting of stainless steel and brass.
